(19) United States
(12) Patent Application Publication
(10) Pub. No.: US 2007/0222888 A1
(43) Pub. Date: Sep. 27, 2007

(54) Web cam with auto-adjusting angled image device

(75) Inventors: Shi-Ying Xiao, Taipei (TW); Hui-Mei Zhang, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (CN)

(21) Appl. No.: 11/385,754

(22) Filed: Mar. 22, 2006

(51) Int. Cl. H04N 5/225

(52) U.S. Cl. 348/373

(57) ABSTRACT

The present invention relates to a web cam coupled to a computer system, an in particular to a web cam with an automatic image angle adjustment device responsive to rotation of a housing of the camera. Once a user rotates the housing of the web cam, the web cam will cause electrical contact or disengagement of a conductor relative to a contact, and thereby generate a feedback signal for enabling the computer system to give a counter rotation to an angled image and align the angled image with a display.

### BACKGROUND OF THE INVENTION

1. Field of the Invention

The present invention relates to a web cam device, and in particular to a web cam which can automatically adjust an image display angle in a display.

2. Description of the Prior Art

Normally, a web cam is placed on a desk-top or attached to the frame of a monitor, such that an image on the local end user can be retrieved by a remote end user. However, because the resolution on the display is usually set by the display card at predetermined resolutions of, for example, 640×480, 800×600, or 1024×768 dpi (dots per inch), so that the displayed image is rectangular rather than square, once the user rotates the web cam to an angle, for example 90°, the viewed image will become correspondingly narrower (e.g., from 640 to 480), and each side of the newly image will have a thick black rim. Therefore, the web cam has to be placed carefully (usually on a horizontal surface) so as to obtain a regular viewed image (hereinafter viewed image) and avoid any unpleasant angled viewed image (hereinafter angled image).

Taiwanese patent number M260783 disclosed a unique way to overcome the defect caused by the angled image, wherein a pair of rollers (or so-called roller switches) is positioned separately at different angles. Once the user rotates the web cam to an angle, one of the rollers will move from one side to another. Thus, the computer can detect the rotation of the web cam, and the angled image can be further calibrated to a viewed image.

However, the rollers disclosed in M260783 have the disadvantage that it is hard to clearly distinguish the various angles to which the web cam may be rotated. In addition, the rollers and the corresponding components are costly to manufacture. Still further, the rollers have to be carefully installed and positioned at two different predetermined angles, which will cause the great difficulty in assembling the web cam.

### SUMMARY OF THE DISCLOSURE

It is an objective of the present invention to provide a web cam which can adjust an angled image to a viewed image.

To accomplish the objective mentioned above, a web cam for retrieving an image to be viewed includes a pivot having a conductor, a housing coupled to the pivot, and a circuit board positioned within the housing. The circuit board has a plurality of contacts, and when the housing rotates to an angle and retrieves an angled image, the conductor engages one of the contacts so as to generate a feedback signal, which is supplied to a computer to indicate the angle of the camera, enabling a corresponding adjustment of the image. Thus, the angle of the image to be viewed may be rotated to compensate for the angle of the web cam.

### BRIEF DESCRIPTION OF THE DRAWINGS

FIG. 1A is an exploded isometric view of the present invention.

FIG. 1B is an isometric view showing an interior of the housing illustrated in FIG. 1.

FIG. 1C is another exploded isometric view of the present invention.

FIG. 1D is an isometric view of an assembled housing according to the present invention.

FIG. 2A is an isometric view of the present invention after a 90 degree rotation to the right.

FIG. 2B is a front view showing an interior of the housing according to FIG. 2A.

FIG. 2C is an exploded view of the rotated housing of FIG. 2A FIG. 3A is an isometric view of the present invention after a 90 degree rotation to the left.

FIG. 3B is a front view showing an interior of the housing according to FIG. 3A.

FIG. 3C is an exploded view of the rotated housing of FIG. 3A

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

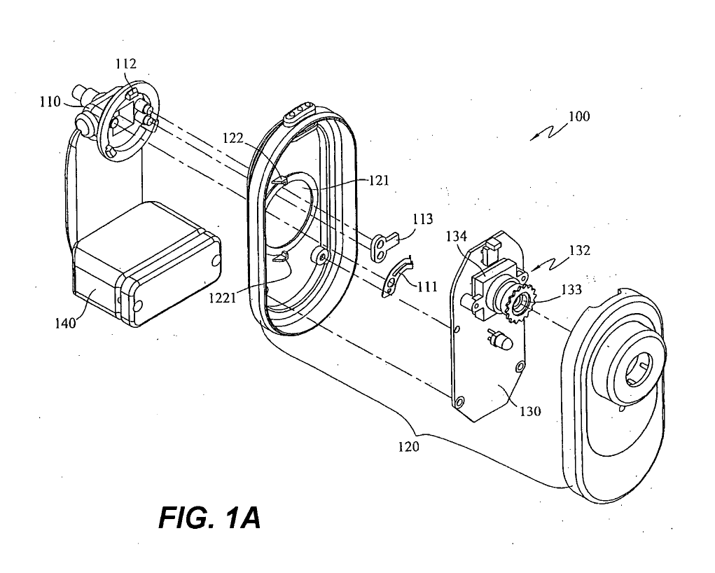

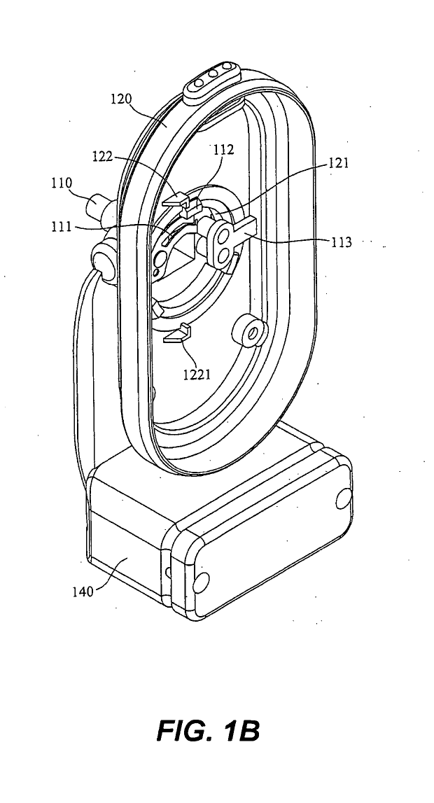

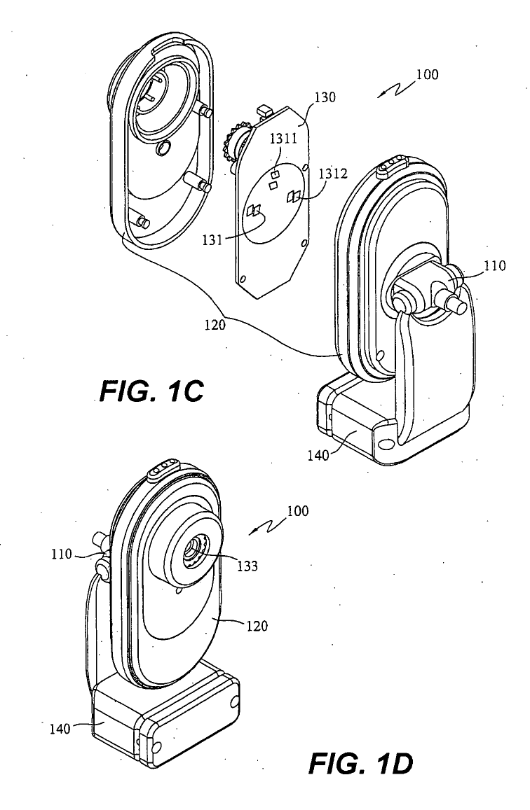

Please refer to FIGS. 1A˜1D, which show a web cam 100 coupled to a computer system (not shown) for retrieving an image of a local end user, such that the local end user may watch the image of himself or herself on the computer system, and/or a remote user may watch the viewed image from the display of a remote computer, depending on the setup of software in the computer system. The web cam 100 comprises a pivot 110 having a conductor 111, hooks 112, rib 113, and a housing 120 for accommodating a circuit board 130 therein such that the housing may be rotated from a first housing position to an angled housing position.

When the housing 120 rotates from the first housing position to the angled housing position, the image rotates from a first image position, in which the image is properly oriented relative to the display, to an angled image position in which the image is no longer properly oriented relative to the display. However, as described below, rotation of the housing 120 causes the conductor 111 to engage one of a plurality of contacts 131, 1311, and 1312 on one side of the circuit board 130 (shown in FIG. 1c), and generate a signal indicative of the angle to which the housing has been rotated, the signal being used to rotate the image from the angled image position back to the first image position. The other side of the electrical board 130 has a camera unit 132 (shown in FIG. 1A), which further has a lens 133 and an image sensor 134. Normally, the conductor 111 constantly engages contact 1311.

The conductor 111 is made of metal or other conductive material, and may have a plate-like configuration for constantly engaging the contacts 131, 1311, or 1312 once the user turns the housing 120 to the right or to the left direction.

The housing 120 has an opening 121 such that the pivot 110 may penetrate the opening 121 and couple to the housing 120, as shown in FIG. 1B. The hooks 112 snap around the inner side of the opening 121 such that the conductor 111 and the rib 113 are retained within the housing 120. A restricting unit includes the rib 113 and stoppers 122, 1221 for limiting the rotation of the housing 120 to a predetermined angle, for example 90 degrees. The rib 113 is fixedly coupled to the pivot 110 to protect the wiring from been twisted and damaged.

A base 140 is commonly used to couple the pivot 110. The base may be placed on a working surface, hooked onto an object, or clamped to the frame of a monitor, according to technology well-known to those skilled in the art.

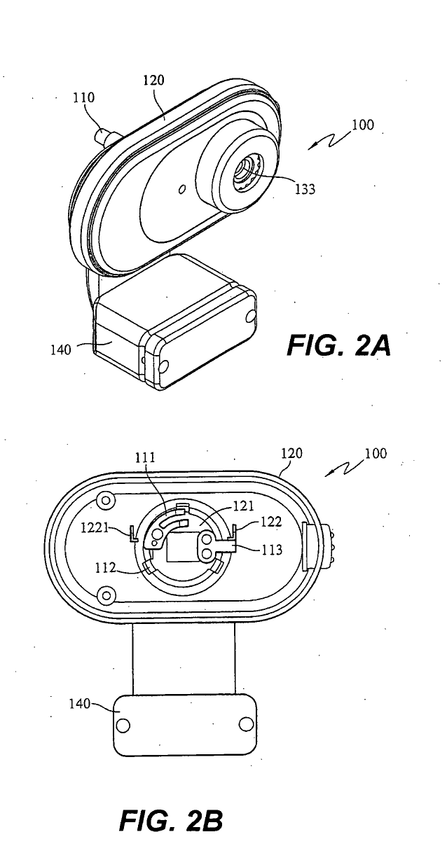

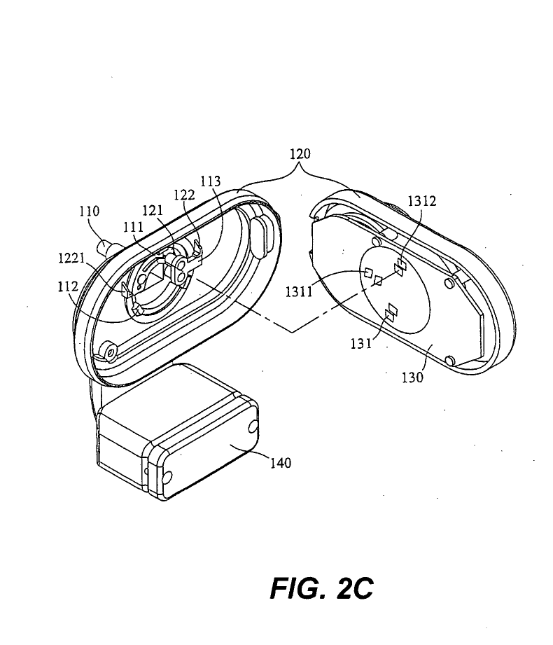

Please refer to FIG. 2A˜2C. Once the user turns the housing 120 to the right at an angle, for example 90 degrees, the stopper 122 will be biased against the rib 113 and prevent further rotation of the housing. During the rotating process of the housing 120 from a first housing position to an angled housing position, the image obtained from the camera rotates correspondingly from the first image position to the angled image position. However, when the contact 1312 engages conductor 111, a corresponding feedback signal will be generated and received by the computer system, and the image will be rotated in a direction opposite the direction of rotation of the camera to counter the rotation of the angled image, i.e., from the angled position back to the first position, and thereby return the angled image to a normal orientation so as to fit the display and eliminate black bars at the side of the image.

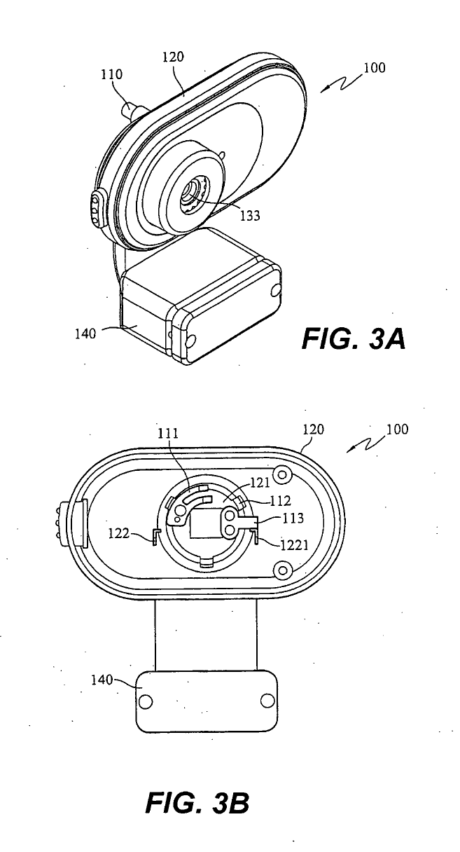

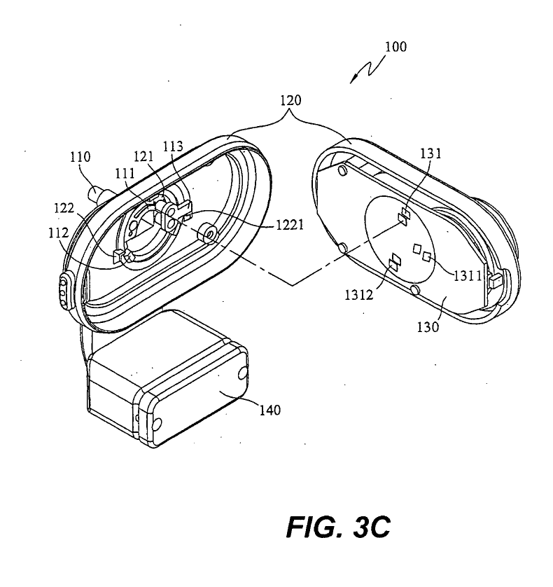

Please refer to FIG. 3A˜3C. Once the user turns the housing 120 to the left at an angle, for example 90 degrees, the stopper 1221 will be biased to the rib 113 and prevent further rotation of the housing. During the rotating process of the housing 120 from a first housing position to an angled housing position, the non-rotation-compensated image is rotated from a first, properly oriented image position to an angled image position. When the contact 131 engages the conductor 111, a corresponding feedback signal will be generated and received by the computer such that the image will be rotated counter to the angle of rotation of the camera for adjusting the angled image to return the image back to a normal orientation and fit the display, eliminating black bars at the side of the image.

If there is only one contact 1311 and one conductor 111 in the housing 120, the contact and conductor may be configured such that once the contact 1311 disengages from the conductor 111, the computer may force the angled image to give a counter rotation so as to compensate for rotation of the camera. The image comparison technology may compare the viewed image with the angled image, and then force the angled image to undergo an exact counter rotation so as to assume a non-rotated orientation and fit the display. Therefore, the image can be shown either on the display of a local end or a remote end computer without suffering from the effects of camera rotation.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A web cam having an image angle compensation device, said web cam coupled to a computer for retrieving an image, comprising:
a pivot;
a pivotal housing coupled to the pivot;
a conductor;
a circuit board having a plurality of contacts;
wherein one of the conductor and circuit board is pivotable with the housing, such that the conductor and circuit board pivot relative to each other, and
wherein as the housing rotates from a first position to a rotated position, an image retrieved by the camera rotates with the camera from a first image position to an angled image position until the conductor engages a corresponding one of the contacts,
wherein when the conductor engages said one of the contacts, a feedback signal indicative of an angle to which the housing has been rotated is generated, and
wherein the feedback signal is supplied to the computer to rotate the image retrieved by the camera from the angled image position back to the first image position, thereby aligning the image with a display screen of the computer and eliminating black bars at a side of the displayed image.

2. The web cam as claim 1, wherein the conductor is a metal plate.

3. The web cam as claim 1, wherein the web cam further has a base which is coupled to the pivot.

4. The web cam as claim 1, wherein the housing has an opening for receiving the pivot, and the pivot has a hook for retaining the pivot in the housing.

5. The web cam as claim 1, wherein the housing has a restricting unit therein.

6. The web cam as claim 5, wherein the fining unit comprises a rib coupled to the pivot, and at least a stopper located around the opening.

7. A web cam coupled to a computer system, comprising:
a rotatable housing;
wherein a circuit board and a conductor are located within the housing;
wherein the circuit board has at least a contact;
whereby the rotation of the housing causes electrical contact between the conductor and the contact, which generates a feedback signal for adjusting an orientation of an image on a display of a computer system.

8. A web cam coupled to a computer system, comprising:
a rotatable housing;
wherein a circuit board and a conductor are located within the housing;
wherein the circuit board has a contact which is constantly in engagement with the conductor;
whereby the rotation of the housing disconnects the conductor and the contact, thereby generating a feedback signal for adjusting an orientation of an image on a display of the computer system.
